(19) United States
(12) Patent Application Publication
(10) Pub. No.: US 2005/0152158 A1
(43) Pub. Date: Jul. 14, 2005

(54) DC-to-DC converter

(75) Inventors: Stefan Gut, Mauerbach (AT); Harald Schweigert, Vienna (AT)

Correspondence Address: MONTE & MCGRAW, PC, 4092 SKIPPACK PIKE, P.O. BOX 650, SKIPPACK, PA, 19474, US

(73) Assignee: SIEMENS AG OSTERREICH, Vienna (AT)

(21) Appl. No.: 11/056,038

(22) Filed: Feb. 11, 2005

(30) Foreign Application Priority Data
Aug. 12, 2002 (AT) A 1218/2002
Jun. 23, 2003 (WO) PCT/AT03/00175

(51) Int. Cl. H02M 3/335

(52) U.S. Cl. 363/16

(57) ABSTRACT

A DC-to-DC converter comprises a transformer (UET), which has at least one primary winding (WP) and at least one secondary winding (WS), and comprises at least one controlled primary switch (SP1, SP2), via which an input direct current voltage (UE) can be applied periodically and with a preset pulse duty factor and/or with a preset frequency to the at least one primary winding. The DC-to-DC converter also comprises at least one controlled synchronous switch (SS1, SS2), which is assigned to the at least one secondary winding and which is provided for synchronous rectification. A trigger circuit (AST) common to the primary and secondary side is provided with a digital processor (DSP) that, derived from a common clock generator (CLK), generates both the switching pulses for the at least one primary switch (SP1, SP2) as well as those for the at least one synchronous switch (SS1, SS2).

The invention concerns a DC-to-DC converter having a transformer with at least one primary winding and at least one secondary winding, having at least one controlled primary switch through which an input direct voltage can be applied periodically and with predeterminable pulse duty factor and/or predeterminable frequency to the at least one primary winding, and having at least one controlled synchronous switch for synchronous rectification assigned to the at least one secondary winding.

An example of a DC-to-DC converter of this type appears, for instance, in EP 1 148 624 A1. The DC-to-DC converters disclosed in that document are designed as flux or flyback converters, whereby the one or more primary-side controlled switches are controlled by a usual drive circuit with pulse width modulation.

Synchronous rectification at the secondary side of DC-to-DC converters, usually using MOSFETs, has the advantage of lower losses, because the forward resistances of MOSFETs, for example, are lower than for ordinary diodes. To be sure, other problems arise in relation to the switching times and switching delay times of controlled switches. Those become significant primarily at higher voltages.

For switching power supplies with, for example, 24 V output voltage, the working voltage rating of the rectifier diodes or switching elements must in practice be in the range of 150-200 V. That is determined primarily by the transformation ratio of the transformer and the input (line) voltage range, quite generally determined by voltage peaks and/or overvoltages. However, the body diodes inherent in MOSFETs are usually distinctly slower for MOSFETs with inverse voltages of 150-200 V than for MOSFETs with only 50 V inverse voltages. More accurately stated, the reverse recovery times in the first case are at least 200 ns, and in the second case at least 80 ns. In contrast, conventional rectifier diodes with 200 V inverse voltage have delay times of 35 ns.

Now there is a problem due to the fact that a short circuit appears on the secondary side of the transformer during the reverse recovery time because, considering for example a flux converter with two secondary diodes or switches, one diode continues to conduct during the current commutation while the other has already started to conduct. The resulting short circuit current magnetizes the leakage inductance of the transformer and, after conclusion of the commutation process, generates a high-energy overvoltage pulse that is stored either in a special voltage-limiting network or in the winding capacitances of the transformer windings, and is converted to heat when the primary transistor(s) is/are switched on. Furthermore, the overvoltage peaks can result in further heating of the winding materials due to electrical and core losses because of their high-frequency components.

The drive for secondary-side synchronous rectifiers, with MOSFETs as their switches, according to EP 1 148 624 A1, cited above, employs a secondary-side digital signal processor to drive the one or more synchronous switches, whereby the trigger pulses required for the signal processor are derived from the secondary voltage of the transformer.

Even though driving the secondary synchronous switches using a digital signal processor offers unarguable advantages with respect to flexibility, deriving the trigger pulse from the secondary voltage of the transformer must be considered highly disadvantageous because it results in a rigid bond to the clock pulse of the primary pulse width modulation pulse. Furthermore, the delay of the pulses through the transformer is an impairment. The advantages of using a digital signal processor are largely canceled by this situation.

Thus it is an object of the invention to provide the most nearly ideal operation possible without unwanted short-circuit states or overvoltages.

This object is attained with a DC-to-DC converter of the type initially stated, in which, according to the invention, a common drive for the primary and the secondary sides is provided by means of a digital signal processor which, using a common clock, generates both the switching pulses for the at least one primary switch and also those for the at least one synchronous switch.

Thanks to the invention, completely independent drive of the primary-side and secondary-side switches is possible, so that the operation can be optimized by suitable adjustment of the switching-on and switching-off times of the controlled switches.

The invention exhibits special advantages if the at least one secondary-side synchronous switch is designed as a MOSFET, because in this case of the presence of the body diodes can be taken particularly well into consideration.

One advantageous embodiment provides a current sensor in the primary circuit to provide information to the drive circuit.

In many cases it is advantageous for it to be designed as a flux converter. Then one can provide that the drive circuit is adjusted to close the secondary switch before the primary switches. That allows zero-voltage switching, protects the controlled switch from dangerous overvoltages, and allows use of switches with lower inverse voltage rating.

It is also convenient for the drive circuit to be adjusted so as to control the primary and secondary switches in the sense of energy feed-back.

Another advantageous embodiment provides that the drive circuit is adjusted so as to drive the primary and secondary switches in the sense of cycling the power between the primary and secondary sides to maintain auxiliary supply voltages. Thus power supply for the drive circuit or other auxiliary circuits can be assured, especially when idling, which is always a critical operating state for switching converters.

The advantages of the invention also come particularly to bear if the drive circuit is adjusted so as to store the delay times between their switching commands and the switching of the individual controlled switches, and to refer to them in the process of control.

If the drive circuit lies on a single potential level, so that the primary and/or secondary switches can be triggered separately, the drive circuit can be designed more simply. For instance, no opto-bus is required for communication if multiple processors are used.

The invention is explained in more detail in the following, by means of exemplary resultant forms which are clarified in the drawing. In the drawing, the figures show:

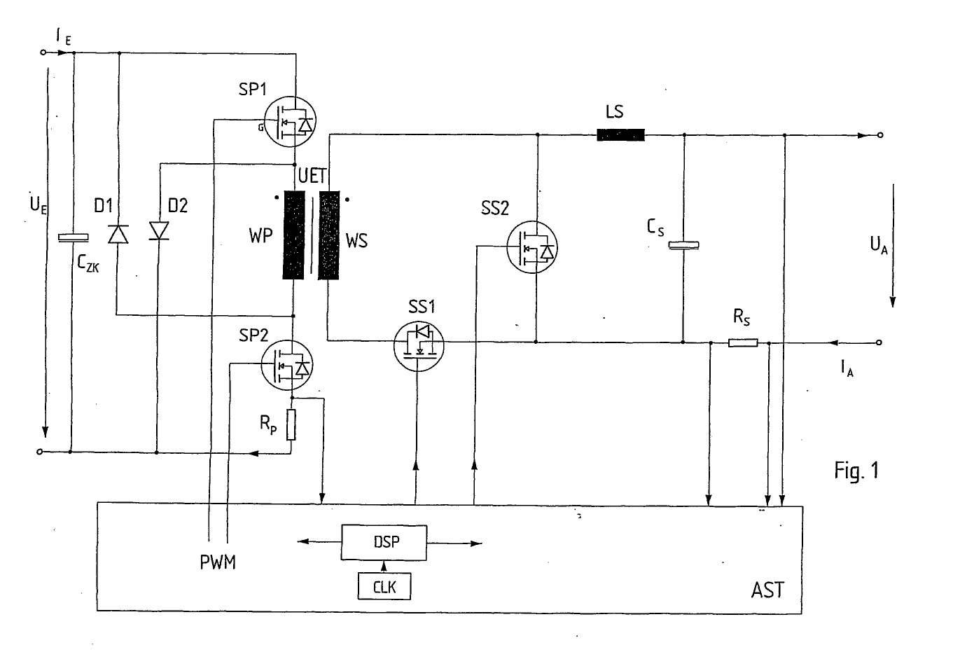

FIG. 1A simplified circuit diagram of an initial embodiment of a switching converter according to the invention.

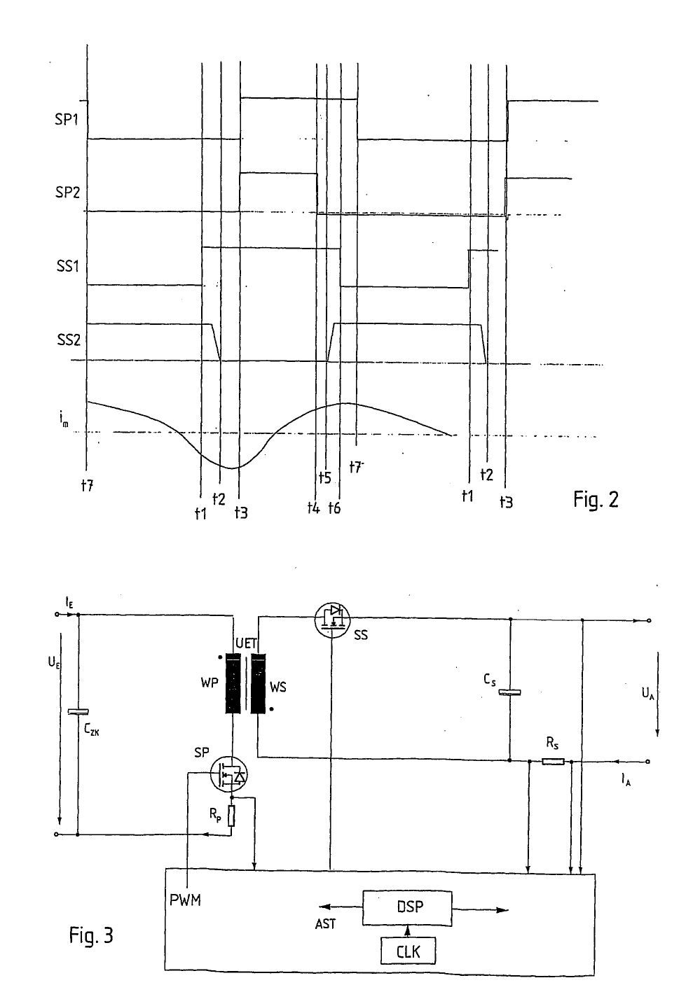

FIG. 2 In a diagram, the time course of the switching signals for the switches of the embodiment of FIG. 1.

FIG. 3A simplified representation of the fundamental circuit diagram of a variant of the invention designed as a flyback converter.

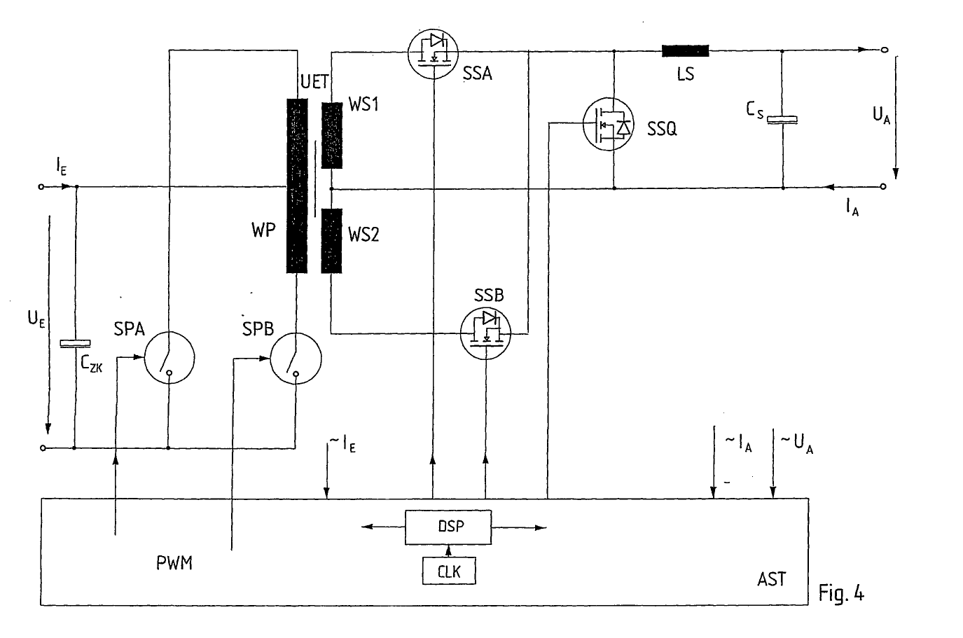

FIG. 4A basic circuit diagram of a variant of the invention with a push-pull circuit.

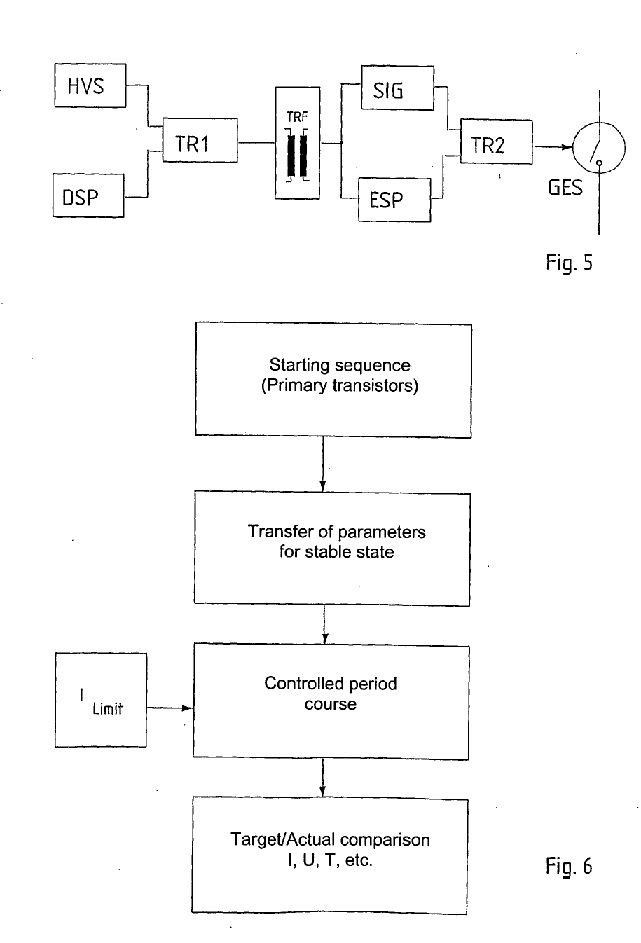

FIG. 5A block diagram of a possibility for potential-isolated drive of the power switches, and

FIG. 6A logical flow diagram for the switch control.

In the circuit of FIG. 1, which shows a flux converter with secondary-side synchronous rectification, an input direct voltage U_{E}, which here is applied to a capacitor C_{ZK}, is led symmetrically to the primary winding WP of a transformer UET through two controlled primary switches SP1, SP2. For switching power supplies, he input direct voltage U_{A} can, for instance, be an intermediate circuit voltage obtained by rectifying a 230/400 power line voltage.

The controlled primary switches SP1, SP2, here are MOSFETs with integrated body diodes, so that the doubled and symmetrical arrangement of these switches halves the required inverse voltage rating, compared with use of just one primary switch. Two demagnetizing diodes D1, D2 are provided in the known manner. They bridge over the distances WP-SP1 and WP-SP2, respectively. As is usual, a primary sensor resistance R_{P} or another current sensor is placed in the primary current loop. It provides information about the course of the primary current.

Two controlled synchronous switches SS1, SS2 are provided on the secondary side, namely, a first synchronous switch SS1 following the secondary winding WS in the series arm and a second synchronous switch SS2 following in the shunt arm. The first synchronous switch SS1, which can also be in the positive branch, acts as a synchronous rectifier. The second controlled switch acts as an asynchronous switch. A series inductance LS followed by a capacitor C_{S}, to which the output voltage U_{A} is series inductance LS followed by a capacitor C_{S}, to which the output voltage U_{A} is applied, complete the flux converter. If the leakage inductance of the transformer is not excessive, it can even be demagnetized through the winding capacitance and the demagnetizing diodes D1, D2 can be omitted. In this case, it is possible for the switching-on time to be longer than 50% of the period. In the negative branch of the secondary side, a series resistance R_{S} is provided as a current sensor. The current sensor can optionally also be on the primary side.

A drive circuit AST is provided to drive all the controlled switches. It contains a digital processor DSP as its core unit, as well as the driver stages, etc., required for the direct control of the switches. The driver circuit is also provided with the actual values of the input current I_{E}, the output current I_{A} and the output voltage U_{A} so that they can be compared with the stored or preset target values. This comparison determines, among other things, the pulse duty cycle of the pulse-width-modulated triggering of the primary switches SP1, SP2. This pulse duty cycle always remains less than 1:1 because of the time required for demagnetization. The supply voltage for the drive circuit AST is not shown more specifically. It can be obtained from the intermediate loop voltage or from an auxiliary winding of the transformer during operation. A number of variants for this are known to those skilled in the art.

It should be emphasized that a processor, DSP, does not necessarily mean a physical unit. Rather, such a digital processor can be made, for example, from a multiplicity of microprocessors connected through a common data bus.

A more detailed explanation of the invention follows now, with reference to the circuit of FIG. 1 and the time diagram of FIG. 2.

The individual lines of FIG. 2 cover one complete period of the drive. The trigger signals for the controlled switches SP1, SP2 (primary) and SS1, SS2 (secondary) are shown in the first four lines. The fifth line shows the approximate course of the magnetizing current iₘ. Times that are prominent and significant for the progress of the triggering within one period are marked as t1 to t7.

During the time period (t3−t1) the asynchronous current driven by the series inductance LS is distributed to the synchronous switches SS1 and SS2. The entire asynchronous current is then absorbed at synchronous switch SS2 during the time period (t2−t1). The current is commutated to the synchronous switch SS1, already switched on, due to the cutting off of the MOS channel because of the high flow potential of the body diode of the synchronous switch SS2 and because of the low-resistance secondary winding WS.

Now both primary switches SP1, SP2 switch on simultaneously at time T3 and energy flows from the primary side into the series inductance LS of the secondary side. No overvoltage pulses appear at the secondary synchronous switches SS1, SS2 because their commutation has already been accomplished in the zero-voltage condition at the primary side.

At time t4 the primary switch SP2 switches off, so that the magnetizing current and the current in the primary leakage inductance is shorted through the primary switch SP1 and diode D1. Thus the voltage in all the windings collapses to nearly zero, with the currents maintained.

The asynchronous [free-running] synchronous switch SS2 is switched on at time t5, just to make sure that the current can be commuted. Because of the primary short circuit, the secondary winding WS of the transformer prevents the current being conducted on through the rectifying synchronous switch SS1 and the current is commuted at the free-running synchronous switch SS4.

The channel of the synchronous switch SS1 is cut off in the nearly zero-current state at time t6 because the current, as noted above, has changed to synchronous switch SS2.

The primary switch SP1 is also cut off at time t7. That is followed by demagnetization of the transformer UET through the demagnetizing diodes D1 and D2. This demagnetization must be terminated before time t1 of the next period.

One can see from the process above that, thanks to the invention, the primary and secondary switching times can in principle be selected quite independently of each other. One will obviously utilize this potential choice such that, as much as possible, no undesired short circuits or overvoltages occur during the entire switching process. That includes, for instance, the measure that the secondary synchronous switches are switched on before the primary switches in each cycle. Also, the “stepwise” switching on and off, as shown in FIG. 2, can be accomplished without problem thanks to the invention.

The representation according to FIG. 2 concerns a steady operating state, but it must be clear that the switching times or the delay or shift of the switching times can be adapted dynamically to various operating conditions; for instance, to fluctuations of the input voltage or to load fluctuations and/or to temperature fluctuations, etc.

The drive circuit can be made using microprocessors. For example, the applicants have achieved good results with the following microprocessors: Texas Instruments, TMS 320LF2406A, 40 Mips/40 MHz/2.5 K RAM/32 K flash, 16 PWM channels, 16 ADC; or Motorola DSP56F803, 64 K flash/4 K RAM, 6 PWM channels, 8 ACD.

In the example embodiments the entire drive circuit AST is drawn as a single block; but it should be clear to one skilled in the art that there can also be distribution over various blocks here without the overall concept of independent drive being altered at all.

The DC isolation of the primary and secondary sides is a significant point. It is accomplished in the example embodiment shown by means of a transformer, here called transformer UET. Aside from the fact that different DC isolation would be possible, e.g., through photoelectric elements, it is naturally required that attention be paid to the required DC isolation between the primary and secondary sides in the design of the drive circuit. To reduce the expense required, the trigger pulses for each channel (switch) can, for instance, be conducted to the controlled switches over isolation transformers. The trigger pulses are conveniently brought to enough energy so that on the secondary side the transformer mentioned can get additional energy for the internal driver stages of the controlled switches from these trigger pulses. Solutions with opto-couplers are also possible. In each individual case it would also be necessary to decide which concept of DC isolation is even cost-favorable.

The DC isolation mentioned, using a transformer, is sketched in FIG. 5. And a digital signal processor DSP in the drive circuit provides the trigger pulses for a controlled switch through a driver TR1 to the DC-isolating transformer TRF. An auxiliary supply HVS can supply the driver TR1. There is separation of signal and power on the other, DC-isolated side of the transformer, represented by one box SIG for the signal and one box ESP for energy storage. The signal, and, on the other hand, the required power, are now introduced to another driver TR2, and the driver controls a controlled switch GES.

It should also be noted that the invention makes possible energy feedback from the secondary side to the primary side through suitable alteration of the switch trigger pulse, without additional cost for hardware. For this purpose, the secondary synchronous switch SS2 is switched on, so that the inductance LS establishes a negative current. When the secondary synchronous switch SS2 is switched off and the secondary synchronous switch SS1 is switched on simultaneously, this current is conducted through the secondary winding WS of the transformer UET. Capacitor C_{ZK} is recharged through the body diodes of the non-triggered primary switches SP1 and SP2, with the secondary inductance LS or the choke acting as a step-up unit. Then energy feedback is necessary. It is initiated by the driver circuit AST with its processor DSP if the cycling operation is needed to maintain auxiliary power supplies or if power line buffer operation becomes necessary, initiated by a suitable supplemental circuit. That is the case in a battery charger, for instance, where the buffer operation is fed back into the intermediate circuit to supply other primary loads.

For example, such a feedback makes possible maintenance of a primary and/or secondary auxiliary supply by moving energy back and forth. The transformer is always triggered and additional auxiliary windings, not shown here but mentioned previously are also supplied. This is of particular interest in idling operation, in which all pulses are in fact stopped after the output voltage is reached if no load is connected. The feedback mentioned can, for example, also be provided for deliberate discharge of a battery provided on the secondary side or for supply of the intermediate circuit (input voltage U_{E}) in case of emergency.

The circuit in FIG. 3 shows that the invention can also be applied to flyback converters. In the figure, comparable parts or values are designated with the same reference symbols as in FIG. 1. In the circuit of FIG. 3 there is only a single primary switch SP and only a single synchronous rectifier switch SS on the secondary side. The drive circuit AST again receives information about the primary current I_{E} and about the output current I_{E} or the output voltage U_{A}. Of course, other information, such as about the temperature, can also be provided to the drive circuit AST. Dynamic adaptation to operating conditions is also possible with this circuit. As there are no overvoltages with a flyback converter, as with a flux converter, the principal advantage of the invention in this case is that of the possibility of compensating for the delay times. Energy feedback is also possible with a flyback converter.

A further variant of the invention should be discussed in connection with FIG. 4. Here the transformer UET has a primary winding WP with a center tap and two secondary windings WS1 and WS2. The upper or the lower half of the primary winding WP can be switched to ground from the positive pole of the input voltage U_{E} through the primary switches SPA, SPB. Full-wave rectification can be accomplished on the secondary side using the controlled synchronous switches SSa and SSb. Here another synchronous switch SSQ is used as an asynchronous switch. The asynchronous current of the secondary inductance LS can be kept away from the transformer, so that it cannot heat up, through this switch, which, like all the other switches, can be designed as a MOSFET.

The free-running synchronous switch SSQ required a lower cutoff voltage than the rectifying synchronous switches SSA and SSB, as it needs only to block the cutoff voltage of one of the two transformer windings WS1 or WS2, and so can be made with lower resistance. That also reduces the copper loss of the transformer or repeater coil, by about a third if the free-running current is completely absorbed by the synchronous switch SSQ. For simplicity, the individual primary side or secondary side current and voltage sensors by means of which information about the actual status is supplied to the driver circuit, AST, are not shown.

A variant of the invention, not shown, in which a separate free-running synchronous switch SSQ as in FIG. 4 is not required, can be made if both the secondary synchronous switches SSA and SSB are deliberately controlled to be free-running. Then, to be sure, the free-running current flows entirely through the secondary windings WS1 or WS2 of the transformer UET, but produces lower total loss in switches SSA and SSB because the current is divided when the switches SSA and SSB are on, with a corresponding reduction in power loss.

FIG. 6 shows a possible course of the intelligent triggering according to the invention. A starting sequence is established for the primary transistors, so that the parameters important for a stable steady state are transmitted. That is followed by the controlled course of periods, for example, such as is shown in FIG. 2. A target/actual comparison, which can affect particularly the output voltage and current, but can also concern the temperature, makes contact and the parameters can be changed again, according to it. The limit established for the primary current, is designated as I-Limit, acting on the controlled progress of periods. In a first phase of the flow of the periods, the auxiliary supplies are reduced through a separate power supply, series controller, or auxiliary starting resistance. In the second phase, the processor, i.e., its program, starts, possibly with a self-test. The third phase contains the driving of the primary transistors. The secondary transistors (switches) can only be triggered later, as initially the rectification is by the body diodes, to the extent that they are present. That allows a simpler program course and the requirements for processor power can be lower. In the fourth phase, a stable operating state with stable output voltage is reached. Now the secondary switches (MOSFETs) are also triggered and the losses are reduced.

One significant advantage offered by the invention is that the delay times of each individual drive circuit can be considered to assure optimal operation. For example, these delays can be measured using the microprocessor itself in a test run in the balancing of the unit, and can then be referred to in the program. The magnitude of the input voltage U_{E} can also affect the switching speeds of the primary transistors, as the feedback effect of the drain-gate capacitance loads the gate drive more heavily at higher input voltage and the switching speed is reduced. Then the magnitude of the input voltage can be taken into consideration on balancing the circuit, or referred to during operation.

As already mentioned, the delay times between the drive circuit and the individual controlled switches can be taken into consideration. It is convenient to store these delay times in the drive circuit for each of the individual branches; for example, four branches, according to FIG. 1). In general the delay times are different for each branch because of the unavoidable part tolerances and in the MOSFET tolerances, especially for the gate capacitance. For example, in compensation by bridging over the insulation segments (e.g., Optocouplers) one can determine and store the individual delays by means of direct lines. The control circuit or the digital signal processor can determine the difference between a transmitted switching command using separated inputs and can calculate the difference between a transmitted switching command and the actual execution of the switching command, and store them.

The digital signal processor DSP of the drive circuit AST can also compute the switching-on times digitally. At the time, none of the generally useful ramp generators are present and they need only be started by the processors so that the required fineness of control can be attained. In one practical example embodiment with a power supply clock rate of 50 KHz, the processor uses 25-ns steps.

1. DC-to-DC converter having a transformer (UET) with at least one primary winding (WP) and at least one secondary winding (WS; WS1, WS2), having at least one controlled primary switch (SP1, SP2; SPA, SPB), through which an input direct voltage (U_{E}) is applied periodically and with a predeterminable pulse duty cycle and/or predeterminable frequency to the at least one primary winding, and having at least one controlled rectifying synchronous switch (SS1; SSA, SSB) assigned to the at least one secondary winding, and with a common drive circuit (AST) common to the primary and s secondary sides, with a digital processor (DSP) which, deriving clock pulses from a common clock pulse generator (CLK), produces both the switching pulses for the at least one primary circuit and those for the at least one rectifying synchronous switch,
characterized in that
the drive circuit (AST) with the digital processor (DSP) is adjusted so that within each switching period it turns on the at least one rectifying synchronous switch (SS1; SSA, SSB) before the at least one primary controlled primary switch ((SP1, SP2: SPA; SPB) by a predetermined time period (t3−t1) established by the drive circuit.

2. DC-to-DC converter according to claim 1, characterized in that the at least one secondary-side synchronous switch (SS1; SSA, SSB) is designed as a MOSFET.

3. DC-to-DC converter according to claim 1, characterized in that a current sensor (R_{P}) is provided in the primary circuit to provide information to the drive circuit (AST).

4. (canceled)

5. (canceled)

6. DC-to-DC converter according to claim 1, characterized in that the drive circuit (AST) is adjusted to control the primary and secondary switches (SP1, SP2; SPA, SPB and SS; SSA, SSB) in the sense of energy feedback.

7. DC-to-DC converter according to claim 1, characterized in that the drive circuit (AST) is adjusted to control the primary and secondary switches (SP1, SP2: SPA, SPB and SS1; SSA, SSB) in the sense of cycling the power between the primary and secondary sides to maintain auxiliary power supplies.

8. DC-to-DC Switching converter according to claim 1, characterized in that the drive circuit (AST) is adjusted to store the delay times between its switching commands and the switching of the individual controlled switches and to refer to them in the course of control.

9. DC-to-DC converter according to claim 1, characterized in that the drive circuit (AST) lies on a single potential level, whereby the primary and/or secondary switches (SP1, SP2, SPA, SPB, SP; SS1, SS2, SSA, SSB, SSQ, SS) are separately potential-controlled.
